(19) United States
(12) Patent Application Publication
(10) Pub. No.: US 2024/0256294 A1
(43) Pub. Date: Aug. 1, 2024

(54) PROGRAM MANAGEMENT SYSTEM, PROGRAM MANAGEMENT METHOD, AND INFORMATION STORAGE MEDIUM

(71) Applicant: AVGIDEA, INC., Tokyo (JP)

(72) Inventor: Teppei YAGIHASHI, Tokyo (JP)

(21) Appl. No.: 18/199,380

(22) Filed: May 19, 2023

(30) Foreign Application Priority Data
Feb. 1, 2023 (JP) 2023-014137

(51) Int. Cl. G06F 9/445

(52) U.S. Cl. CPC G06F 9/44521; G06F 9/44594

(57) ABSTRACT

An input data storing unit stores input data to be entered into a program. A program receiving unit receives a program transmitted from a program storage system. An input data input unit enters the input data into the program. An output data obtaining unit obtains an output from the program when the input data is entered into the program. A program deleting unit deletes the program from the user system in response to when a predetermined use condition of the program is satisfied.

### CROSS-REFERENCE TO RELATED APPLICATIONS

The present application claims priority from Japanese application JP 2023-014137 filed on Feb. 1, 2023, the content of which is hereby incorporated by reference into this application.

### BACKGROUND OF THE INVENTION

### 1. Field of the Invention

The present invention relates to a program management system, a program management method, and an information storage medium.

### 2. Description of Related Art

JP2022-162364A describes an information processing system in which a server receives input text from a user terminal via a network and enters the input text into a trained model, thereby obtaining a quantitative prediction result regarding various economic events, for example.

### SUMMARY OF THE INVENTION

In the technique described in JP2022-162364A, when the data processing using a program, such as prediction with a trained model, is executed, the data needs to be transmitted from a user terminal to an external server even if the user does not want to transmit the data, such as highly confidential data, to the outside.

On the other hand, when a user downloads a program from an external system, such as an external server, a developer of the program or an administrator of the external system may not want the user to freely execute data processing using the program without restriction.

One or more embodiments of the present invention have been conceived in view of the above, and an object thereof is to provide a program management system, a program management method, and an information storage medium that, while preventing a user from transmitting data entered into a program to the outside, enable the user to execute processing of the data using the program stored in an external system and restrict the use of the program by the user.

In order to solve the above described problems, a program management system according to the present invention includes a program storage system and a user system, wherein the program storage system includes transmission request receiving means for receiving a transmission request of a program and program transmitting means for transmitting the program to the user system in response to a reception of the transmission request, the user system includes input data storing means for storing input data to be entered into the program, program receiving means for receiving the program from the program storage system, input means for entering the input data into the program, output obtaining means for obtaining an output from the program when the input data is entered into the program, and program deleting means for deleting the program from the user system in response to when a predetermined use condition of the program is satisfied.

In one aspect of the present invention, the transmission request receiving means receives the transmission request associated with location data indicating a location of the input data. The program transmitting means transmits the program associated with the location data to the user system. The input means enters the input data obtained from a location indicated in the location data into the program.

In one aspect of the present invention, the program transmitting means transmits a program selected from a plurality of programs to the user system.

In one aspect of the present invention, the user system includes user-side transmission request receiving means for receiving a transmission request for the program from a client, and transmission request transmitting means for transmitting a transmission request of the program to the program storage system in response to a reception of the transmission request from the client. The transmission request receiving means receives the transmission request from the user system.

In this aspect, the user-side transmission request receiving means may receive the transmission request, which is associated with location data indicating a location of the input data, from the client. The transmission request transmitting means may transmit a transmission request of the program to the program storage system without transmitting the location data to the program storage system. The input means may enter the input data, which is obtained from a location indicated in the location data, into the program.

Alternatively, the input means may enter the input data into the program, the input data being entered by a user through an operation on the client after the program is received from the program storage system.

In one aspect of the present invention, the input means enters the input data into the program, the input data being obtained from a predetermined location.

In one aspect of the present invention, the program deleting means deletes the program from the user system in response to when an input of the input data to the program and acquisition of an output from the program according to the input are performed once.

In one aspect of the present invention, the program deleting means deletes the program from the user system upon request.

In this aspect, the program deleting means may delete the program from the user system upon request from a developer of the program.

In one aspect of the present invention, the program is a machine learning model.

A program management method according to the present invention includes the steps of receiving a transmission request of a program by a program storage system, transmitting the program to a user system by the program storage system in response to a reception of the transmission request, the user system storing input data to be entered into the program, receiving the program by the user system, the program being transmitted from the program storage system, entering the input data into the program by the user system, obtaining, by the user system, an output from the program when the input data is entered into the program, and deleting the program from the user system by the user system in response to when a predetermined use condition of the program is satisfied.

An information storage medium according to the present invention is an information storage medium storing a program management program that causes a computer storing input data to receive a program from a program storage system, enter the input data into the program, obtain an output from the program when the input data is entered into the program, and delete the program from the computer in response to when a predetermined use condition of the program is satisfied.

### BRIEF DESCRIPTION OF THE DRAWINGS

FIG. 1 is a diagram illustrating an example of a computer network according to an embodiment of the present invention;

FIG. 2 is a diagram illustrating an example of a use start screen;

FIG. 3 is a functional block diagram showing an example of functions implemented in a program storage system and a user system;

FIG. 4 is a flow chart showing an example of processing executed by a user client, the program storage system, and the user system according to an embodiment of the present invention;

FIG. 5 is a functional block diagram showing an example of functions implemented in the program storage system and the user system according to a modification of the embodiment; and

FIG. 6 is a flow chart showing an example of processing executed by the user client, the user system, and the program storage system according to the modification of the embodiment of the present invention.

### DETAILED DESCRIPTION OF THE INVENTION

An embodiment of the present invention will be described below with reference to the accompanying drawings.

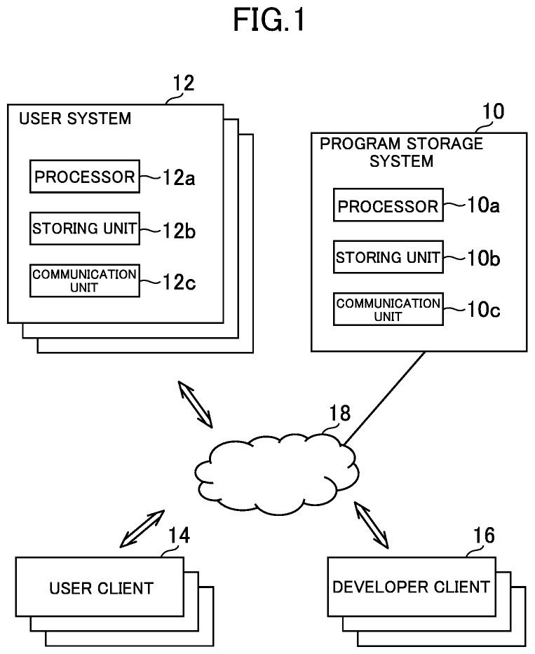

FIG. 1 is a diagram illustrating an example of a computer network 18 according to an embodiment of the present invention. As shown in FIG. 1, the computer network 18 according to the present embodiment is connected to a program storage system 10, a plurality of user systems 12, a plurality of user clients 14, and a plurality of developer clients 16.

The program storage system 10, the user systems 12, the user clients 14, and the developer clients 16 are connected to the computer network 18, such as the Internet.

The program storage system 10 according to the present embodiment is a computer system including one or more server computers.

As shown in FIG. 1, the program storage system 10 includes a processor 10a, a storing unit 10b, and a communication unit 10c, for example. The program storage system 10 may be a cloud system that provides a cloud service for supporting distribution of programs, for example. The program may be a machine learning model, such as a trained model. Alternatively, the program may be a function.

The processor 10a is a program control device, such as a CPU, that operates in accordance with a program installed in the program storage system 10, for example. The storing unit 10b is a storage device, such as a ROM and a RAM, or a hard disk drive. The storing unit 10b stores programs to be executed by the processor 10a. The communication unit 10c is a communication interface, such as a network board and a wireless LAN module.

The user system 12 according to the present embodiment is a computer system including one or more server computers. The user systems 12 according to the present embodiment can be used by different users. A particular user system 12 is accessible from a user client 14 of a user who can use the user system 12. On the other hand, a user system 12 is not accessible from a user client 14 of a user who cannot use the user system 12 or from a developer client 16.

As shown in FIG. 1, the user system 12 includes a processor 12a, a storing unit 12b, and a communication unit 12c, for example. The user system 12 may be a cloud system that provides cloud services, such as cloud storage purchased by a user of the user system 12.

The processor 12a is a program control device, such as a CPU that operates in accordance with a program installed in the user system 12, for example. The storing unit 12b is a storage device, such as a ROM and a RAM, or a hard disk drive. The storing unit 12b stores programs to be executed by the processor 12a. The communication unit 12c is a communication interface, such as a network board and a wireless LAN module.

The user client 14 is a computer, such as a personal computer, a tablet terminal, and a smartphone used by a user who executes data processing using a program. The user can access the program storage system 10 and the user system 12 that is available to the user via the user client 14 of the user, but cannot access the user system 12 that is not available to the user.

The developer client 16 is a computer, such as a personal computer, a tablet terminal, and a smartphone, used by the developer of the program. The developer can access the program storage system 10 via the developer client 16 of the developer, but cannot access the user system 12.

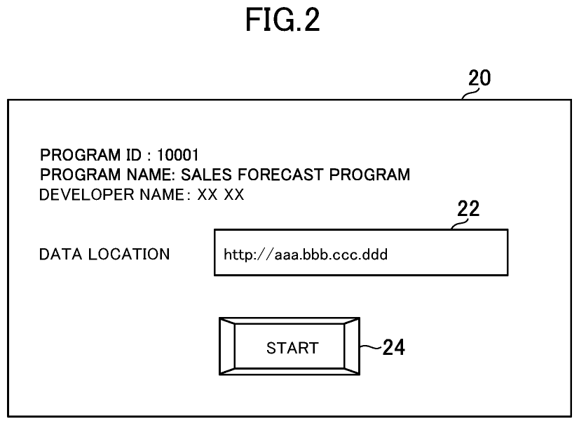

FIG. 2 is a diagram illustrating an example of a use start screen 20 displayed on the display of the user client 14 in the present embodiment. The program storage system 10 according to the present embodiment stores a plurality of programs. A user of the user system 12 logs into the program storage system 10 via the user client 14 of the user. The user performs an operation of selecting a program to be used for data processing, such as prediction and analysis, from among a plurality of programs stored in the program storage system 10. The use start screen 20 associated with the selected program is then displayed on the display of the user client 14.

Subsequently, the user inputs a character string, which represents the location (e.g., URL, path) of input data to be entered into the program, to an entry form 22 disposed on the use start screen 20. The location may be a location of the database to be connected. The user performs a selection operation, such as a click, on a start button 24 disposed on the use start screen 20. The selected program (a copy of the program stored in the program storage system 10) is then transmitted from the program storage system 10 to the user system 12 of the user. The processing of the input data stored in the user system 12 using such a program is then started.

In the following, the functions of the program storage system 10 and the user system 12, and the processing executed by the user client 14, the program storage system 10, and the user system 12, relating to the transmission of a program and data processing using the program will be described.

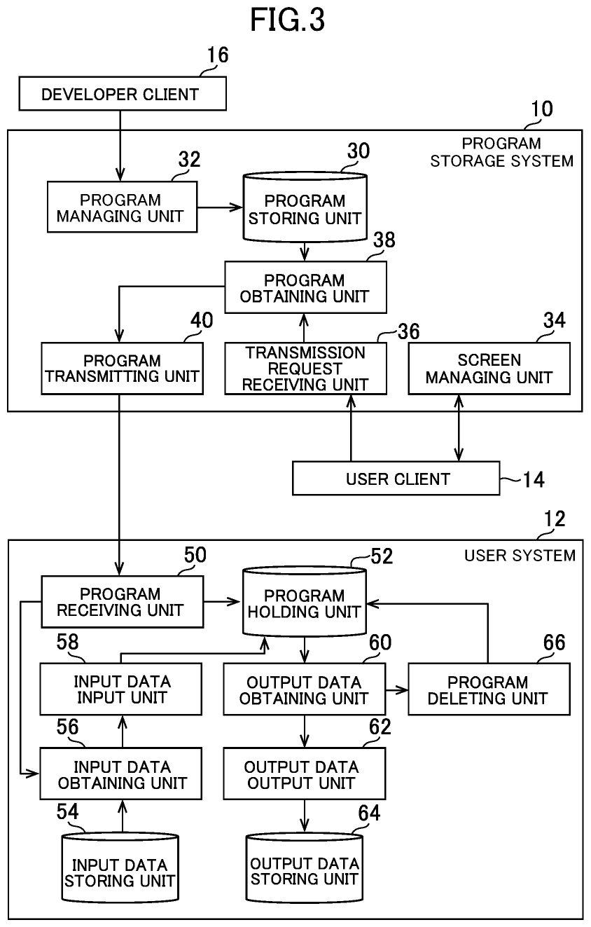

FIG. 3 is a functional block diagram showing an example of functions implemented in the program storage system 10 and the user system 12 according to the present embodiment. All of the functions shown in FIG. 3 need not be implemented in the program storage system 10 and the user system 12 according to the present embodiment, and functions other than those shown in FIG. 3 may be implemented.

As shown in FIG. 3, the program storage system 10 according to the present embodiment functionally includes, for example, a program storing unit 30, a program managing unit 32, a screen managing unit 34, a transmission request receiving unit 36, a program obtaining unit 38, and a program transmitting unit 40. The program storing unit 30 is implemented mainly by the storing unit 10b. The program managing unit 32, the transmission request receiving unit 36, and the program transmitting unit 40 are mainly implemented by the communication unit 10c. The screen managing unit 34 is mainly implemented by the processor 10a and the communication unit 10c. The program obtaining unit 38 is mainly implemented by the processor 10a.

The functions described above may be implemented by executing, on the processor 10a, a program that is installed in the program storage system 10, which is a computer, and includes instructions corresponding to the functions. Such a program may be supplied to the program storage system 10 via a computer-readable information storage medium, such as an optical disk, a magnetic disk, a magnetic tape, a magneto-optical disk, and a flash memory, or via the Internet.

As shown in FIG. 3, the user system 12 according to the present embodiment functionally includes, for example, a program receiving unit 50, a program holding unit 52, an input data storing unit 54, an input data obtaining unit 56, an input data input unit 58, an output data obtaining unit 60, an output data output unit 62, an output data storing unit 64, and a program deleting unit 66. The program receiving unit 50 is mainly implemented by the communication unit 12c. The program holding unit 52, the input data storing unit 54, and the output data storing unit 64 are mainly implemented by the storing unit 12b. The input data obtaining unit 56, the input data input unit 58, the output data obtaining unit 60, the output data output unit 62, and the program deleting unit 66 are mainly implemented by the processor 12a.

The functions described above may be implemented when a program that is installed in the user system 12, which is a computer, and includes instructions corresponding to the above-described functions is executed on the processor 12a. The program may be supplied to the user system 12 via a computer-readable information storage medium, such as an optical disk, a magnetic disk, a magnetic tape, a magneto-optical disk, and a flash memory, or via the Internet.

The program storing unit 30 stores, for example, a plurality of programs in the present embodiment.

In the present embodiment, for example, the program managing unit 32 receives a program from the developer client 16 and stores the received program in the program storing unit 30. In the present embodiment, for example, a developer of a program can upload the program to the program storage system 10 via the developer client 16 of the developer. The program to be uploaded may be associated with meta-data indicating an identifier (program ID) of the program, a program name, and a developer name, for example.

In the present embodiment, for example, the screen managing unit 34 generates a screen, such as the use start screen 20 shown in FIG. 2, and transmits the generated screen to the user client 14. The use start screen 20 is to be displayed on the display of the user client 14. In this regard, the screen managing unit 34 may generate a use start screen 20 in which the contents of the metadata associated with the program is disposed.

In this embodiment, the transmission request receiving unit 36 receives a request for transmitting a program, for example. For example, the transmission request receiving unit 36 receives, from the user client 14, a transmission request for a program selected by the user. The transmission request receiving unit 36 may receive a transmission request associated with the location data indicating the location of the input data.

For example, assume that, when the use start screen 20 shown in FIG. 2 is displayed on the display of the user client 14, the user performs a selection operation on the start button 24 disposed on the use start screen 20. In this case, the user client 14 may send, to the program storage system 10, a transmission request associated with the identifier (user ID) of the user of the user system 12, the program ID of the selected program, and the location data indicating the location entered in the entry form 22. The transmission request receiving unit 36 may receive the transmission request.

In the present embodiment, for example, the program obtaining unit 38 obtains a program selected by the user from a plurality of programs. For example, a program identified by the program ID associated with the transmission request may be obtained. For example, the program obtaining unit 38 obtains a program, which is a copy of the program stored in the program storing unit 30, from the program storing unit 30.

In the present embodiment, for example, the program transmitting unit 40 transmits a program to the user system 12 when the transmission request is received. The program transmitting unit 40 may transmit a program associated with the location data indicating the location of the input data to the user system 12. The program transmitting unit 40 may transmit a program selected from a plurality of programs to the user system 12. For example, the program transmitting unit 40 transmits the program obtained by the program obtaining unit 38 and the location data associated with the transmission request to the user client 14 of the user who has transmitted the transmission request.

The program storage system 10 may store data in which the user ID and the address of the user system 12 are associated with each other. The program transmitting unit 40 may transmit the program to the address corresponding to the user ID associated with the transmission request.

In the present embodiment, the program receiving unit 50 receives a program from the program storage system 10, for example. For example, the program receiving unit 50 receives a program and location data transmitted by the program transmitting unit 40. In the present embodiment, the program receiving unit 50 outputs the program to the program holding unit 52, for example.

In the present embodiment, the program holding unit 52 stores a program received by the program receiving unit 50 (a copy of the program stored in the program storage system 10), for example.

In the present embodiment, the input data storing unit 54 stores input data to be entered into a program, for example. The input data is a target of data processing by the program, for example. The input data stored in the input data storing unit 54 is associated with a location, such as a path or a URL, and can be identified based on the location data associated with the transmission request.

In the present embodiment, the input data obtaining unit 56 obtains input data stored in the input data storing unit 54, for example. For example, the input data obtaining unit 56 may obtain input data from a location indicated by the location data transmitted by the program transmitting unit 40 and received by the program receiving unit 50.

In the present embodiment, the input data input unit 58 enters input data into a program, for example. The input data input unit 58 may enter input data obtained from the location indicated by the location data into the program. For example, the input data input unit 58 enters the input data obtained by the input data obtaining unit 56 into the program held by the program holding unit 52.

In the present embodiment, the output data obtaining unit 60 obtains an output from the program when input data is entered into the program, for example. For example, the output data obtaining unit 60 obtains output data from the program in response to when the input data is entered into the program held by the program holding unit 52. Such output data indicates a result of data processing (e.g., prediction result, analysis result) on the input data using the program.

In the present embodiment, for example, the output data output unit 62 outputs the output data obtained by the output data obtaining unit 60 to the output data storing unit 64.

In the present embodiment, the output data storing unit 64 stores output data from the output data output unit 62, for example.

In the present embodiment, for example, the program deleting unit 66 deletes a program from the user system 12 in response to when a predetermined use condition of the program is satisfied. In the present embodiment, the program is deleted from the user system 12 without the need of operation of the user of the user system 12 (i.e., the user of the user client 14). For example, the program deleting unit 66 deletes a program from the program holding unit 52 in response to when the program stored in the program holding unit 52 satisfies a predetermined use condition. The developer of the program or the program storage system 10 may set the condition. That is, the condition may be determined in advance by the developer of the program or the administrator of the program storage system 10.

The condition may be an upper limit condition of the number of times the program is used. The program deleting unit 66 may delete the program from the user system 12 in response to when an input of input data to the program and an acquisition of output from the program according to such an input are performed a predetermined number of times (e.g., three times), for example.

Further, the condition may relate to the use period of the program. For example, the program deleting unit 66 may delete a program from the user system 12 in response to when a predetermined period (e.g., three days, one month) is elapsed after the program is output to the program holding unit 52.

Further, the condition may relate to an expiration date of the program. The program deleting unit 66 may delete a program from the user system 12 in response to when a predetermined date (e.g., December 31) has arrived, for example.

The program deleting unit 66 may delete the program from the user system 12 in response to when an input of input data to the program and an acquisition of output from the program according to such an input are performed once.

The program deleting unit 66 may store condition data indicating conditions. The condition data may be a condition common to all programs stored in the user system 12, or a condition set for each program. The program deleting unit 66 may delete a program from the user system 12 in response to when the condition indicated by the stored condition data is satisfied. The program deleting unit 66 may delete a program from the user system 12 in response to when the condition indicated by the condition data and set for the program is satisfied.

The developer of the program may upload the condition data indicating the use condition of the program to the program storage system 10. The program storage system 10 may transmit the condition data to the user system 12. The program deleting unit 66 of the user system 12 may store the condition data. The program deleting unit 66 may delete a program from the user system 12 in response to when the condition indicated by the condition data and set for the program is satisfied.

The condition data set by the administrator of the program storage system 10 may be transmitted from the program storage system 10 to the user system 12. The program deleting unit 66 of the user system 12 may store the condition data. The program deleting unit 66 may delete the program from the user system 12 in response to when the condition indicated by the condition data is satisfied.

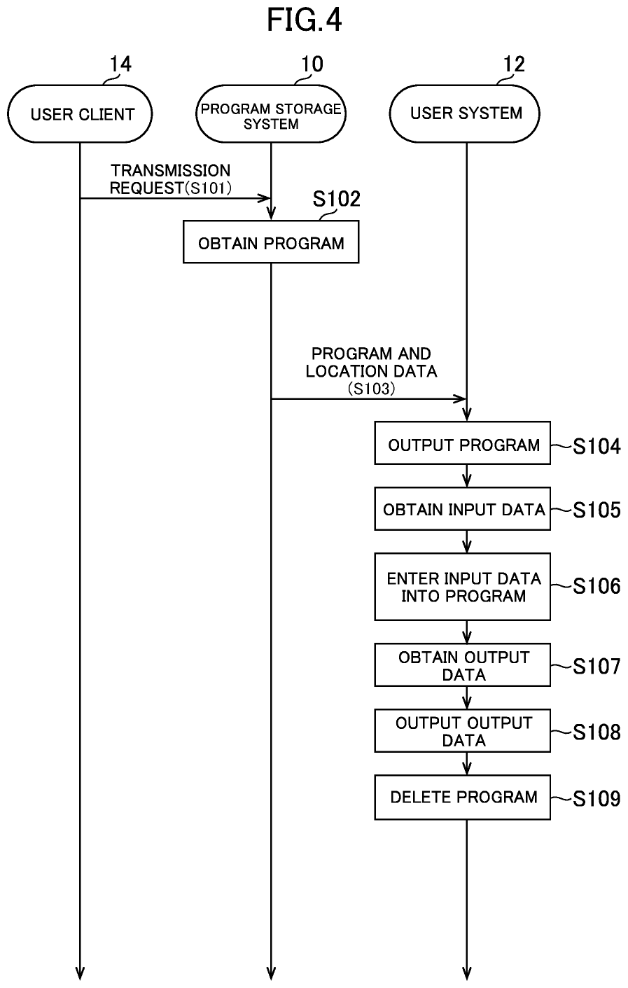

Referring to a flow chart shown in FIG. 4, an example of the processing executed by the user client 14, the program storage system 10, and the user system 12 according to the present embodiment will be described. In this example of the processing, assume that a program is deleted in response to when an input of input data to the program and the acquisition of an output from the program according to the input are performed once.

For example, assume that the user of the user system 12 performs a selection operation on the start button 24 disposed on the use start screen 20 displayed on the display of the user client 14. The user client 14 then transmits a transmission request of a program to the program storage system 10, and the transmission request receiving unit 36 of the program storage system 10 receives the transmission request (S101). For example, the transmission request is associated with a user ID of the user who uses the user system 12, a program ID of the program selected by the user, and location data indicating the location entered in the entry form 22.

The program obtaining unit 38 of the program storage system 10 obtains, from the program storing unit 30, a program (a copy of the program stored in the program storing unit 30) identified by the program ID associated with the transmission request received in the processing in S101 (S102).

The program transmitting unit 40 of the program storage system 10 then transmits, to the user system 12, the program obtained by the processing in S102 and the location data associated with the transmission request received by the transmission request receiving unit 36 in the processing in S101. The program receiving unit 50 of the user system 12 receives the program and the location data (S103).

The program receiving unit 50 of the user system 12 outputs the program received in the processing in S103 to the program holding unit 52 of the user system 12 (S104).

The input data obtaining unit 56 of the user system 12 then obtains the input data from the location indicated by the location data received in the processing in S103 (S105). The input data is stored in the input data storing unit 54.

The input data input unit 58 of the user system 12 inputs the input data obtained by the processing in S105 to the program that is output to the program holding unit 52 in the processing in S104 (S106).

The output data obtaining unit 60 of the user system 12 obtains the output data from the program in response to the input in the processing in S106 (S107).

The output data output unit 62 of the user system 12 outputs the output data obtained by the processing in S107 to the output data storing unit 64 (S108).

The program deleting unit 66 of the user system 12 deletes the program that is output to the program holding unit 52 by the processing in S104 and stored in the program holding unit 52 (S109), and the processing shown in this example is terminated.

Specifically, a program such as a machine learning model is laborious to develop but easy to reproduce, and thus, in general, when a user uses the program, the user does not download the program but uploads data to be entered into the machine learning model to an external system in which the program is stored.

There is a case where the user does not want to output the input data stored in the user system 12 to the outside because the data is highly confidential, for example. In this case as well, as described above, the present embodiment can execute the processing of the input data using the program registered in the program storage system 10 without transmitting the input data stored in the user system 12 to the program storage system 10.

As described above, in the present embodiment, the program is deleted from the user system 12 in response to when a predetermined use condition of the program (e.g., a use condition of the program set by the developer of the program or the administrator of the program storage system 10) is satisfied, for example. As described above, in the present embodiment, the developer of the program and the administrator of the program storage system 10 can restrict the use of the program by the user of the user system 12.

As described above, according to the present embodiment, a user can execute the processing of input data stored in the user system 12 using the program stored in the program storage system 10 while being prevented from outputting the input data to the outside and being restricted in the use of the program.

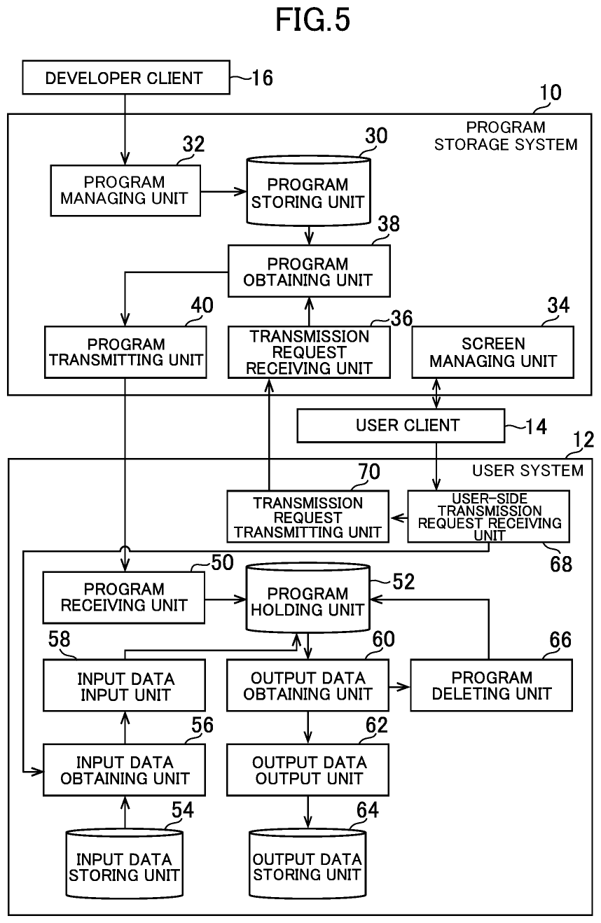

FIG. 5 is a functional block diagram showing an example of functions implemented in the program storage system 10 and the user system 12 according to a modification of the embodiment described with reference to FIGS. 1 to 4. All of the functions shown in FIG. 5 need not be implemented in the program storage system 10 and the user system 12 according to the modification, and functions other than those shown in FIG. 5 may be implemented.

As shown in FIG. 5, the program storage system 10 according to the modification functionally includes, for example, a program storing unit 30, a program managing unit 32, a screen managing unit 34, a transmission request receiving unit 36, a program obtaining unit 38, and a program transmitting unit 40. The program storing unit 30 is implemented mainly by the storing unit 10b. The program managing unit 32, the transmission request receiving unit 36, and the program transmitting unit 40 are mainly implemented by the communication unit 10c. The screen managing unit 34 is mainly implemented by the processor 10a and the communication unit 10c. The program obtaining unit 38 is mainly implemented with the processor 10a.

The functions described above may be implemented by executing, on the processor 10a, a program that is installed in the program storage system 10, which is a computer, and includes instructions corresponding to the functions. This program may be supplied to the program storage system 10 via a computer-readable information storage medium, such as an optical disk, a magnetic disk, a magnetic tape, a magneto-optical disk, and a flash memory, or via the Internet.

As shown in FIG. 5, the user system 12 according to the present embodiment functionally includes, for example, a program receiving unit 50, a program holding unit 52, an input data storing unit 54, an input data obtaining unit 56, an input data input unit 58, an output data obtaining unit 60, an output data output unit 62, an output data storing unit 64, and a program deleting unit 66, a user-side transmission request receiving unit 68, and a transmission request transmitting unit 70. The program receiving unit 50, the user-side transmission request receiving unit 68, and the transmission request transmitting unit 70 are mainly implemented by the communication unit 12c. The program holding unit 52, the input data storing unit 54, and the output data storing unit 64 are mainly implemented by the storing unit 12b. The input data obtaining unit 56, the input data input unit 58, the output data obtaining unit 60, the output data output unit 62, and the program deleting unit 66 are mainly implemented by the processor 12a.

The functions described above may be implemented by executing, on the processor 12a, a program that is installed in the user system 12, which is a computer, and includes instructions corresponding to the functions. The program may be supplied to the user system 12 via a computer-readable information storage medium, such as an optical disk, a magnetic disk, a magnetic tape, a magneto-optical disk, and a flash memory, or via the Internet.

In the present modification, the user-side transmission request receiving unit 68 of the user system 12 receives a transmission request of a program from the user client 14, for example. The user-side transmission request receiving unit 68 may receive a transmission request associated with the location data indicating the location of the input data from the user client 14.

For example, in the present modification, assume that, when the use start screen 20 shown in FIG. 2 is displayed on the display of the user client 14, the user performs a selection operation on the start button 24 disposed on the use start screen 20. The user client 14 may then send, to the user system 12, a transmission request associated with the identifier (user ID) of the user of the user system 12, the program ID of the selected program, and the location data indicating the location entered in the entry form 22.

In the modification, for example, the transmission request transmitting unit 70 of the user system 12 transmits a transmission request for a program to the program storage system 10 when a transmission request is received from the user client 14. The transmission request transmitting unit 70 may transmit the transmission request of the program to the program storage system 10 without transmitting the location data to the program storage system 10.

For example, the transmission request to be transmitted to the program storage system 10 may be associated with a user ID and a program ID associated with the transmission request to be transmitted from the user client 14 to the user system 12. The transmission request to be transmitted to the program storage system 10 may not be associated with the location data associated with the transmission request to be transmitted from the user client 14 to the user system 12.

In the present modification, the transmission request receiving unit 36 of the program storage system 10 receives a transmission request for a program from the user system 12, for example. The transmission request receiving unit 36 may receive a transmission request that is associated with the user ID and the program ID and not associated with the location data.

In the present modification, for example, when a transmission request is received, the program transmitting unit 40 of the program storage system 10 transmits the program to the user system 12. For example, the program transmitting unit 40 transmits the program obtained by the program obtaining unit 38 to the user client 14 of the user who has transmitted the transmission request. In the present modification, the location data indicating the location of the input data is not associated with the program.

In the present modification, the program receiving unit 50 of the user system 12 receives a program transmitted from the program storage system 10, for example. In the present modification, the location data indicating the location of the input data is not associated with the program. In the present modification, the program receiving unit 50 outputs the program to the program holding unit 52, for example.

In the present modification, for example, the input data obtaining unit 56 then obtains input data from the location indicated by the location data associated with the transmission request from the user client 14 to the user system 12.

In the present modification, for example, the input data input unit 58 enters the input data, which is obtained from the location indicated by the location data associated with the transmission request to be transmitted from the user client 14 to the user system 12, into the program.

The functions of the program storing unit 30, the program managing unit 32, the screen managing unit 34, the program obtaining unit 38, the program holding unit 52, the input data storing unit 54, the output data obtaining unit 60, the output data output unit 62, the output data storing unit 64, and the program deleting unit 66 are the same as those described above with reference to FIG. 3, and thus the explanation thereof is omitted.

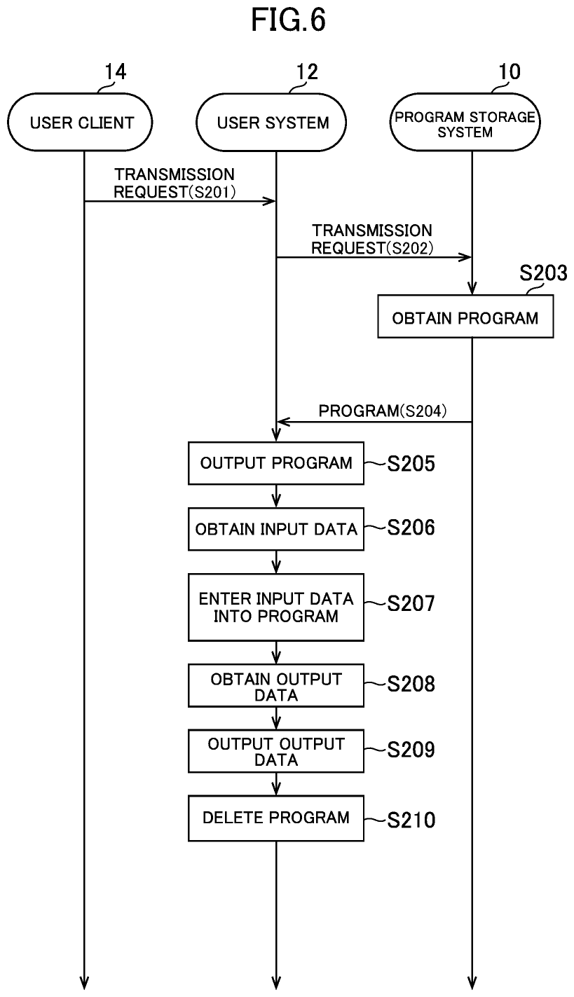

Referring to a flow chart shown in FIG. 6, an example of the processing executed by the user client 14, the user system 12, and the program storage system 10 according to the present modification will be described. In this example of the processing, assume that a program is deleted in response to when an input of input data to the program and the acquisition of an output from the program according to the input are performed once.

For example, assume that the user of the user system 12 performs a selection operation on the start button 24 disposed on the use start screen 20 displayed on the display of the user client 14. The user client 14 then transmits a transmission request for a program to the user system 12, and the user-side transmission request receiving unit 68 of the user system 12 receives the transmission request (S201). For example, the transmission request is associated with a user ID of the user who uses the user system 12, a program ID of the program selected by the user, and location data indicating the location entered in the entry form 22.

The transmission request transmitting unit 70 of the user system 12 transmits a transmission request of the program to the program storage system 10. The transmission request receiving unit 36 of the program storage system 10 receives the transmission request (S202). The transmission request transmitted from the user system 12 to the program storage system 10 in the processing in S202 is associated with the user ID and the program ID associated with the transmission request received in the processing in S201, but is not associated with the location data.

The program obtaining unit 38 of the program storage system 10 obtains the program identified by the program ID associated with the transmission request received in the processing in S202 (a copy of the program stored in the program storing unit 30) from the program storing unit 30 (S203).

The program transmitting unit 40 of the program storage system 10 transmits the program obtained by the processing in S203 to the user system 12. The program receiving unit 50 of the user system 12 receives the program (S204). Unlike the processing in S103, the program transmitting unit 40 does not transmit the location data in the processing in S204.

The program receiving unit 50 of the user system 12 outputs the program received in the processing in S204 to the program holding unit 52 of the user system 12 (S205).

The input data obtaining unit 56 of the user system 12 obtains input data from the location indicated by the location data associated with the transmission request received in the processing in S201 (S206). The input data is stored in the input data storing unit 54.

The input data input unit 58 of the user system 12 enters the input data obtained by the processing in S206 into the program that is output to the program holding unit 52 in the processing in S205 (S207).

The output data obtaining unit 60 of the user system 12 obtains the output data from the program in response to the input in the processing in S207 (S208).

The output data output unit 62 of the user system 12 outputs the output data obtained by the processing in S208 to the output data storing unit 64 (S209).

The program deleting unit 66 of the user system 12 deletes the program that is output to the program holding unit 52 by the processing in S205 and stored in the program holding unit 52 (S210), and the processing shown in this example is terminated.

In the modification as well, a user can execute the processing of input data stored in the user system 12 using the program stored in the program storage system 10 while being prevented from outputting the input data to the outside and being restricted in the use of the program.

In the modification, the location data indicating the location of the input data is not transmitted to the program storage system 10. As such, according to the modification, it is possible to further reduce the risk of leakage of the input data.

Further, in the embodiment and the modification described above, the location data may not be associated with the transmission request.

The location of input data may be determined in advance. The input data obtaining unit 56 may obtain the input data from predetermined location. The input data input unit 58 may input the input data obtained from the predetermined location in the program.

Alternatively, the user may be able to enter input data into the user client 14 via an input device, such as a keyboard.

The input data obtaining unit 56 may obtain input data that is entered by the user through the operation of the user client 14 after the program is received from the program storage system 10.

The input data input unit 58 may enter input data, which is entered by the user through the operation of the user client 14 after the program is received from the program storage system 10, into the program.

In this manner, the user can easily input the input data to be entered into the program, and thus the user can easily verify whether the program is suitable for the desired data processing.

Alternatively, the user may upload a file of the input data from the user client 14 to the user system 12.

The input data obtaining unit 56 may obtain the data uploaded to the user system 12 after the program is received from the program storage system 10.

The input data input unit 58 may enter the data, which is uploaded to the user system 12 after the program is received from the program storage system 10, into the program.

Further, the developer of the program may grant the usage authorization to the user who is authorized to use the program.

In this case, the program storage system 10 may determine whether to permit the transmission of the program based on the user ID associated with the transmission request received by the transmission request receiving unit 36. If it is determined that the program is permitted to be transmitted to the user identified by the user ID, the program may be transmitted to the user system 12 of the user. On the other hand, if it is determined that the program is not permitted to be transmitted to the user identified by the user ID, the program may not be transmitted to the user system 12 of the user.

Further, the input data obtaining unit 56 may obtain data not only from the input data stored in the input data storing unit 54 but also from external resources other than the user system 12 and the program storage system 10. The data obtained from the external resource may be entered into the program together with the input data stored in the input data storing unit 54.

The data uploaded by the developer to the program storage system 10 may be transmitted to the user system 12 together with the program. The data uploaded by the developer may be entered into the program together with the input data stored in the input data storing unit 54.

The data obtained from the external resource and the data uploaded by the developer may be entered into the program together with the input data stored in the input data storing unit 54.

The program deleting unit 66 may delete a program from the user system 12 in response to a request. In this regard, the program deleting unit 66 may delete the program from the user system 12 in response to a request from the developer of the program. For example, the developer of the program may transmit a delete instruction associated with the program ID of the program and the user ID from the developer client 16 to the program storage system 10. Upon receiving the delete instruction, the program storage system 10 may transmit the delete instruction associated with the program ID to the user system 12 of the user identified by the user ID. Upon receiving the delete instruction, the program deleting unit 66 of the user system 12 may delete the program held in the program holding unit 52 from the user system 12.

In this manner, for example, when an illegal use of the program is found, the developer of the program can delete the program from the user system 12.

Further, the program deleting unit 66 may delete the program from the user system 12 in response to a request from the administrator of the program storage system 10.

A plurality of locations may be indicated in the location data described above. Regarding the locations indicated in the location data, input data may be obtained from each location, and such input data may be entered into a program.

The present invention is not limited to the embodiment described above.

For example, the functions of the program storage system 10 and the user system 12 are not limited to those described above. For example, the program storage system 10 may not include the screen managing unit 34, and the user system 12 may include the screen managing unit 34.

The specific character strings and numerical values described above, and the specific character strings and numerical values in the drawings are illustrative only, and are not limited to these character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A program management system comprising:
a program storage system; and
a user system, wherein
the program storage system includes:
at least one processor; and
at least one memory device storing instructions which, when executed by the at least one processor, causes the at least one processor to perform operations including:
receiving a transmission request of a program; and
transmitting the program to the user system in response to a reception of the transmission request,
the user system includes:
at least one processor; and
at least one memory device storing instructions which, when executed by the at least one processor, causes the at least one processor to perform operations including:
storing input data to be entered into the program;
receiving the program from the program storage system;
entering the input data into the program;
obtaining an output from the program when the input data is entered into the program; and
deleting the program from the user system in response to when a predetermined use condition of the program is satisfied.

2. The program management system according to claim 1, wherein
receiving the transmission request includes receiving the transmission request associated with location data indicating a location of the input data,
transmitting the program includes transmitting the program associated with the location data to the user system, and
the input data is obtained from a location indicated in the location data.

3. The program management system according to claim 1, wherein
transmitting the program includes transmitting a program selected from a plurality of programs to the user system.

4. The program management system according to claim 1, wherein
wherein the operations performed by the user system further include:
receiving a transmission request for the program from a client; and
transmitting a transmission request of the program to the program storage system in response to a reception of the transmission request from the client, wherein
the program storage system receives the transmission request from the user system.

5. The program management system according to claim 4, wherein
the user system receives the transmission request, which is associated with location data indicating a location of the input data, from the client,
the user system transmits a transmission request of the program to the program storage system without transmitting the location data to the program storage system, and
the input data is obtained from a location indicated in the location data.

6. The program management system according to claim 4, wherein
the input data is entered by a user through an operation on the client after the program is received from the program storage system.

7. The program management system according to claim 1, wherein
the input data is obtained from a predetermined location.

8. The program management system according to claim 1, wherein
deleting the program includes deleting the program from the user system in response to when an input of the input data to the program and acquisition of an output from the program according to the input are performed once.

9. The program management system according to claim 1, wherein
deleting the program includes deleting the program from the user system upon request.

10. The program management system according to claim 9, wherein
deleting the program includes deleting the program from the user system upon request from a developer of the program.

11. The program management system according to claim 1, wherein
the program is a machine learning model.

12. A program management method comprising:
receiving a transmission request of a program by a program storage system;
transmitting the program to a user system by the program storage system in response to a reception of the transmission request, the user system storing input data to be entered into the program;
receiving the program by the user system, the program being transmitted from the program storage system;
entering the input data into the program by the user system;
obtaining, by the user system, an output from the program when the input data is entered into the program; and
deleting the program from the user system by the user system in response to when a predetermined use condition of the program is satisfied.

13. An information storage medium storing a program management program that causes a computer storing input data to:
receive a program from a program storage system;
enter the input data into the program;
obtain an output from the program when the input data is entered into the program; and
delete the program from the computer in response to when a predetermined use condition of the program is satisfied.
